(19) United States
(12) Patent Application Publication
(10) Pub. No.: US 2005/0057390 A1
(43) Pub. Date: Mar. 17, 2005

(54) Electronic devices and systems

(76) Inventor: James M. Okuley, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/664,497

(22) Filed: Sep. 16, 2003

(51) Int. Cl. H04L 17/02; G08C 19/12

(52) U.S. Cl. 341/176

(57) ABSTRACT

Various novel electronic devices and systems are described, including novel keyboards, remote control devices, and computer systems.

The invention relates to electronic systems, and more particularly to novel personal electronic devices and systems including keyboards, remote control devices, and computer systems.

### BRIEF DESCRIPTION OF THE DRAWINGS

Various features of the invention will be apparent from the following description of preferred embodiments as illustrated in the accompanying drawings, in which like reference numerals generally refer to the same parts throughout the drawings. The drawings are not necessarily to scale, the emphasis instead being placed upon illustrating the principles of the invention.

FIG. 1 is a perspective view of a computer system in accordance with some embodiments of the invention.

FIG. 2 is another perspective view of a computer system in accordance with some embodiments of the invention.

FIG. 3 is a perspective view of a keyboard in accordance with some embodiments of the invention.

FIG. 4 is a top view of a keyboard in accordance with some embodiments of the invention.

FIG. 5 is a bottom view of a keyboard in accordance with some embodiments of the invention.

FIG. 6 is a perspective view of a remote control device in accordance with some embodiments of the invention.

FIG. 7 is a top view of a remote control device in accordance with some embodiments of the invention.

### DESCRIPTION

In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

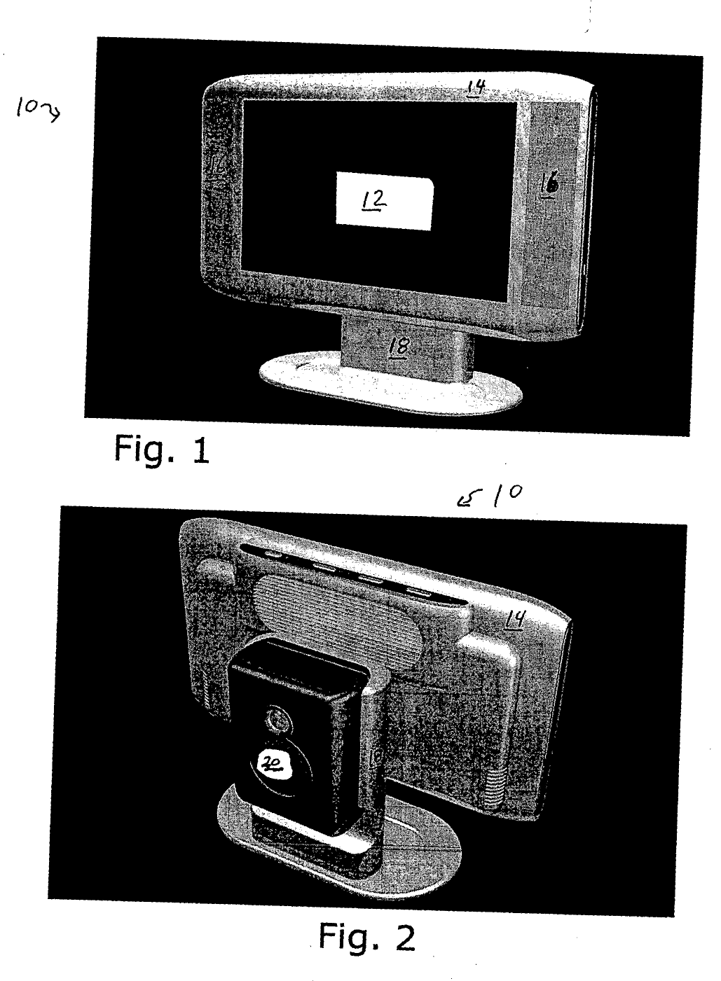

With reference to FIGS. 1-2, an all-in-one electronic system 10 includes a flat panel display 12 mounted in an enclosure 14. The enclosure 14 further includes speakers 16 positioned on either side of the display 12. The enclosure 14 is mounted on and may be integral with a pedestal base 18. Behind the display 12, the pedestal base is adapted to receive a housing 20 which may, for example, enclose a processor-based system.

Either the base 18 or the housing 20 may further include a subwoofer so that the system 10 may provide 2.1 audio output. The system 10 may further cooperate with satellite speakers to provide 5.1 audio output. Preferably, the system 10 including the housing 20 operates quietly to enhance the audio experience.

For example, the system 10 may provide platform having a high degree of convergence that incorporates various entertainment media with a personal computer. For example, the system 10 may be adapted to incorporate one or more of a television, a personal video recorder, a DVD player, a CD player, a DVD burner, a CD burner, a stereo, and an FM radio, among other electronic entertainment devices. For example, the system 10 provides a highly integrated electronic entertainment device which may be well suited for a smaller living space such as a bedroom, a kitchen, a dormitory room or an apartment.

Preferably, the system 10 is adapted for easy set-up. For example, the system 10 may be virtually wire-free. If battery powered, no cord may be required. Otherwise, only the power cord may be required for the initial set-up. The system 10 may support a number of communication devices, including, for example, connection to the internet through any of a wired or wireless broadband connection and broadcast through a cable or satellite connection. The system 10 may be further adapted to control a satellite or cable box. Preferably, the system 10 is further adapted to operate with a wireless keyboard and/or mouse (e.g. for a 2 foot PC experience) and/or a wireless remote control (e.g. to enable a true 10′ media experience).

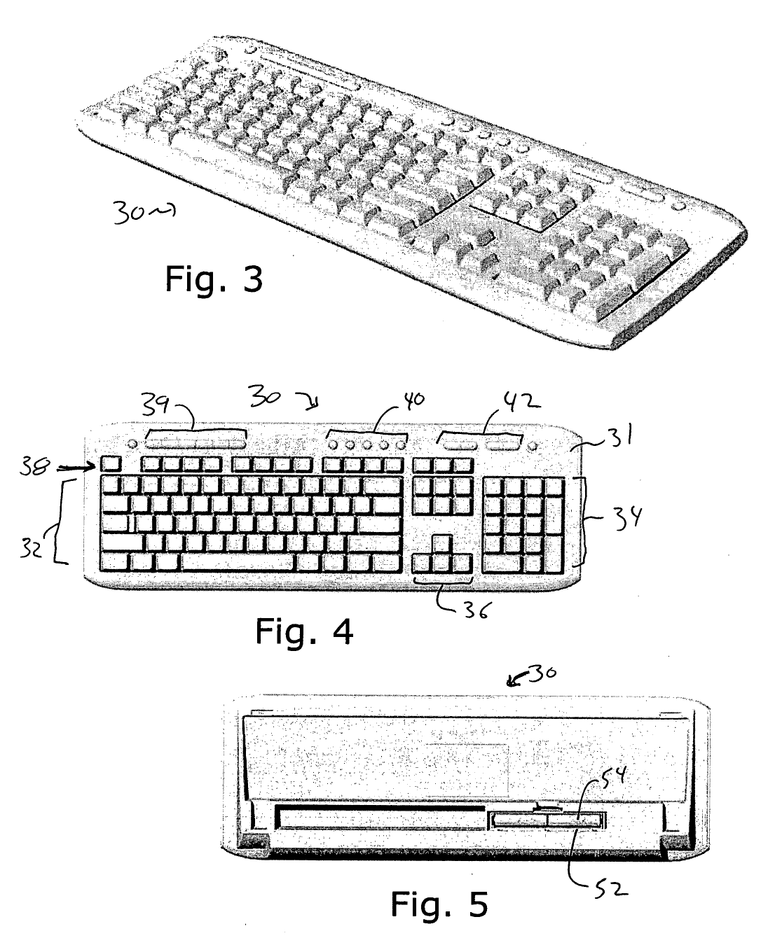

With reference to FIGS. 3-4, a wireless keyboard 30 includes a housing 31 with QWERTY keys 32, together with a numeric keypad 34, arrow keys 36, and various function keys 38 accessible through an outer surface of the housing. The keyboard 30 includes a first set of keys 39 associated with common computer operations such as, for example, one key access to e-mail. The keyboard 30 further includes a second set of keys 40 for operating media devices including a play key, a stop key, a pause key, a rewind key, and a forward key. The keyboard 30 and/or the system 10 may be adapted to respond to the keys 40 in the context of a current media operation. For example, if the user is listening to a CD, the keys 40 would operate on the tracks of the CD. However, if the user is watching a video tape or DVD, the keys 40 would affect the playback of the video. The keyboard 30 further includes a third set of keys 42 associated with common broadcast television operations. For example, the keyboard may includes a key for a channel up operation, a key for a channel down operation, a key for a volume up operation, and a key for a volume down operation. The volume keys may be dedicated to changing the volume of the broadcast audio or may be generally associated with the volume of whatever media is playing. The keyboard 30 further includes a battery compartment 52 adapted to house batteries 54 which provide power for the keyboard 30. Advantageously, incorporating media playback control keys 40 and broadcast associated keys 42 improves the convergence of the various media. Preferably, the keyboard 30 may be adapted to operate with an all-in-one system such as the system 10 described above.

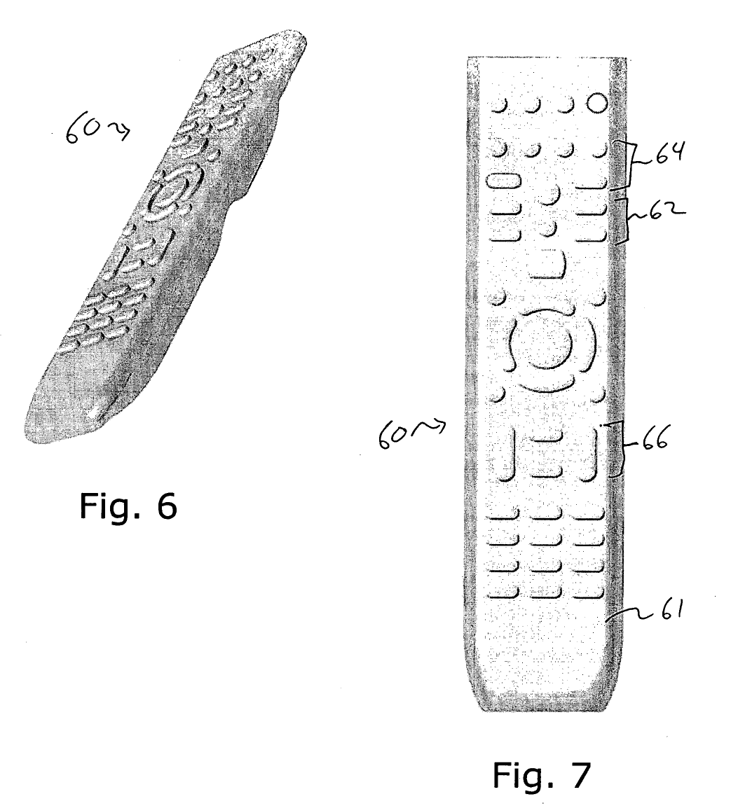

With reference to FIGS. 6-7. a remote control device 60 includes a housing 61 with a first set of keys 62 associated with various media playback controls accessible through an outer surface of the housing 61. For example, keys 62 may be associated with playback of a CD, a video tape, and/or a DVD. Preferably the remote 60 further includes a second set of keys 64 associated with common computer operations. For example, the keys 64 may be associated with opening a file folder which contains various computer media files (e.g. a My Music folder). The remote 60 may be adapted to operate media devices which are integrated with the system 10 as well as external devices (e.g. a separate stereo system). The remote 60 may further include a third set of keys 66 associated with common broadcast television operations (e.g. channel up/down). Advantageously, by including conventional media playback control keys 62, and keys 64 associated with computer operations, and keys 66 associated with broadcast television operations, the remote 60 improves the convergence of the various media. Preferably, the remote 60 may be adapted to operate with an all-in-one system such as the system 10 described above.

The foregoing and other aspects of the invention are achieved individually and in combination. The invention should not be construed as requiring two or more of the such aspects unless expressly required by a particular claim. Moreover, while the invention has been described in connection with what is presently considered to be the preferred examples, it is to be understood that the invention is not limited to the disclosed examples, but on the contrary, is intended to cover various modifications and equivalent arrangements included within the spirit and the scope of the invention.

1. An input device, comprising:
a housing;
a first set of keys accessible on an outer surface of the housing, the first set of keys being associated with media playback control; and
a second set of keys accessible on the outer surface of the housing, the second set of keys being associated with control of a computer operation.

2. The input device of claim 1, further including a third set of keys associated with control of a television.

3. The input device of claim 1, wherein the second set of keys includes a key associated with opening a file folder on a computer.

4. The input device of claim 1, wherein the device comprises a keyboard.

5. The input device of claim 1, wherein the device comprises a remote control.

6. An electronic system, comprising:
a pedestal base;
an enclosure mounted to the pedestal base;
a flat panel display disposed within the enclosure; and
a housing mounted on the pedestal base behind the display, the housing enclosing a processor-based system.

7. The electronic system of claim 6, further comprising:
a pair of speakers disposed inside the enclosure with one speaker positioned on each side of the display.

8. The electronic system of claim 7, further comprising:
a subwoofer disposed in the pedestal base.

9. The electronic system of claim 7, further comprising:
a subwoofer disposed in the housing.

10. The system of claim 6, further comprising:
a wireless input device, comprising:
a second housing;
a first set of keys accessible on an outer surface of the second housing, the first set of keys being associated with media playback control; and
a second set of keys accessible on the outer surface of the second housing, the second set of keys being associated with control of a computer operation.

11. The system of claim 10, wherein the input device further includes a third set of keys associated with control of a television.

12. The system of claim 10, wherein the second set of keys includes a key associated with opening a file folder on a computer.

13. The system of claim 10, wherein the device comprises a wireless keyboard.

14. The system of claim 10, wherein the device comprises a remote control.
